(19) United States
(12) Patent Application Publication
(10) Pub. No.: US 2014/0244426 A1
(43) Pub. Date: Aug. 28, 2014

(54) METHOD FOR GENERATING USER PROFILES

(71) Applicant: BARNESANDNOBLE.COM LLC, New York, NY (US)

(72) Inventors: Jonathan Huizhong Huang, Cupertino, CA (US); Yufan Hu, North Brunswick, NJ (US); Shujane Lee, Belmont, CA (US)

(73) Assignee: barnesandnoble.com llc, New York, NY (US)

(21) Appl. No.: 13/781,259

(22) Filed: Feb. 28, 2013

(51) Int. Cl. G06Q 30/06

(52) U.S. Cl. CPC G06Q 30/0631
USPC 705/26.7

(57) ABSTRACT

A recommendation for a product based on a user profile and product affinity is discussed.

### RELATED APPLICATIONS

This application is related to U.S. application Ser. No. ______ (Attorney Docket BN01.824US), filed Feb. 28, 2013 and titled “System for Generating User Profiles” which application is herein incorporated by reference in its entirety.

### FIELD OF THE DISCLOSURE

The present disclosure generally relates to generating recommendations of content, and more particularly to systems and methods for generating user profiles to assist in making recommendations of content.

### BACKGROUND

Systems for generating recommendations for products or services to users typically operate on data contained in the system. Traditionally, this data is related to the product or service itself or to users' habits with respect to the product or service. For example, in regard to the users' habits, some systems generate recommendations based on users' buying habits such as ‘People who bought this product, also bought that product.’ In regard to the product or service itself, some systems make recommendations such as ‘Here are some other services offered by this provider’ or ‘Here are some other services related to this service.’

Booksellers receive unstructured meta data from hundreds (if not thousands) of book publishers. These publishers typically use their own subject and genre taxonomies to classify the content of a book. These taxonomy nodes are difficult to normalize, leaving booksellers with several definitions of a single node and multiple nodes with the same definition. For example, there may be multiple nodes for “Italian Cooking” and several nodes for Cooking called “Cooking—miscellaneous,” “General Cooking,” and simply “Cooking” The result of this taxonomy is a less than optimal browsing experience for users when they are shopping by subject or genre, or when recommendations are being made.

People looking for their next book to read often do not shop by subject or genre. They are looking for a book that will provide a certain reading experience to them, or a book similar to another book that they have read and loved.

### SUMMARY

The system and method of the present invention generates user profiles with respect to products or services using a user's history maintained in the system.

Although in the preferred embodiment of the present invention described herein, the product is books, those skilled in the art will recognize that the systems and methods of the present invention are equally applicable to other products or services such as music, movies, magazines, games, software, electronics or clothing. The following description is made with respect to book content, but is equally applicable to other forms of content and other products and services.

Booksellers receive unstructured meta data from hundreds or thousands of book publishers. These publishers typically use book attributes such as subject, author, category and genre taxonomies to classify the content of a book.

People looking for their next book to read often do not shop by book attributes. Instead, they are looking for books that are related to those they have read or purchased before.

The present invention recognizes the above problems with the current recommendation system and provides solutions. The system and method generates unique user profiles based on a hierarchy of affinities of books attributes as well as a user's activities that are known to the system, such as readers' preferences, purchases, views and reads of content over a lengthy period of time. This user profile is combined with the functionality of an existing recommendation engine and product attribute correlation determination to generate a set of scores for each book affinity such as subject, author, readers category, price range, category and genre taxonomies. The end result is product or service recommendations that are more accurate and quantitatively aligned with readers' interests than the traditional recommendation engine alone.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 illustrates an exemplary system according to the present invention;

FIG. 2 illustrates a flow chart of a preferred method of the present invention;

FIG. 3 depicts a user's most recent purchase history and the user's cluster affinities;

FIG. 4 depicts a user's affinities in regard to several categories; and

FIG. 5 illustrates the components of an exemplary device.

### DETAILED DESCRIPTION

The advent of electronic reader, which allow user to read books, periodicals, or whatever other material that previously had been available only through printed medium, opens new worlds of opportunity for interaction regarding the written word. Although much of the present disclosure references electronic books, as appreciated by those skilled in the art, the teachings herein are equally applicable to other forms of digital publications such as magazines, newspapers and journals.

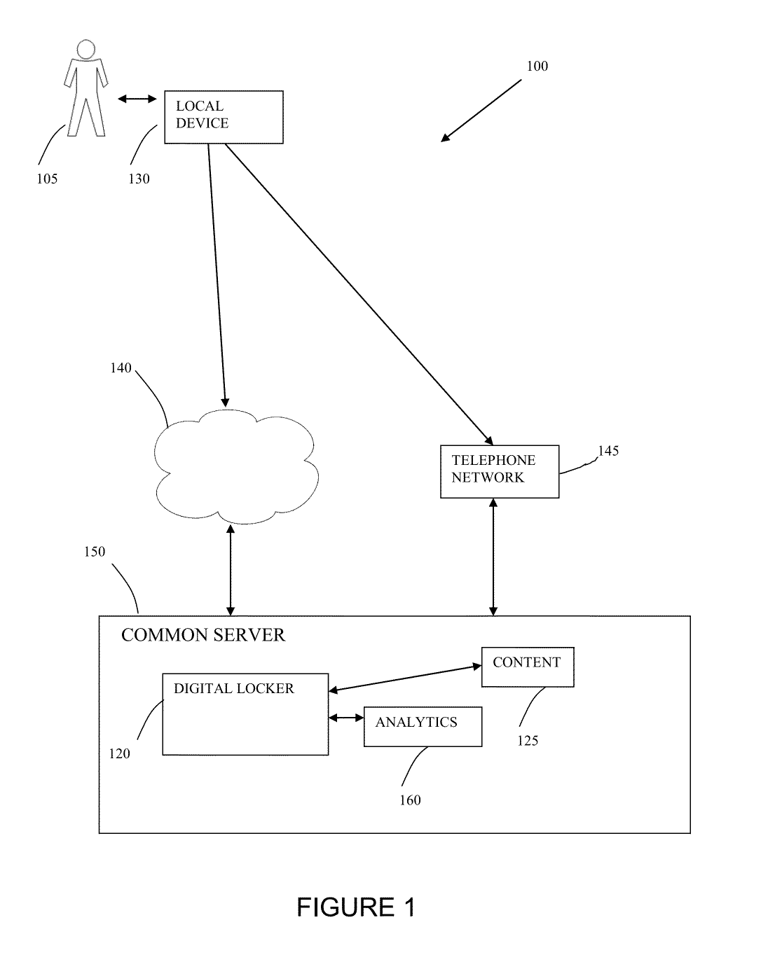

The present invention operates in conjunction with several components including, for example, the electronic publication itself, the software application for reading the electronic publications, the electronic reader device and preferably a remote server system, also known as the “cloud.” FIG. 1 illustrates an exemplary system according to the present invention.

FIG. 1 shows components of an exemplary system according to the present invention. User 105 is an authorized user of system 100 and uses her local device 130 for the reading of digital publications. Many of the functions of system 100 of the present invention are carried out on server 150. As appreciated by those skilled in the art, many of the functions described herein can be divided between the server 150 and the user's local device 130. Further, as also appreciated by those skilled in the art, server 150 can be considered a “cloud” with respect to the user 105 and her local device 130. The cloud can actually be comprised of several servers performing interconnected and distributed functions. For the sake of simplicity in the present discussion, only a single server 150 will be described. The user 105 can connect to the server 150 via the Internet 140, a telephone network 145 (e.g., wirelessly through a cellphone network) or other suitable electronic communication means. User 105 has an account on lending server 150, which authorizes user 105 to use system 100.

Associated with the user's 105 account is the user's 105 digital locker 120 located on the server 150. As further described below, in the preferred embodiment of the present invention, digital locker 120 contains links to copies of digital content 125 previously purchased (or otherwise legally acquired) by user 105.

Indicia of rights to all copies of digital content 125 owned by user 105, including digital content 125, is stored by reference in digital locker 120. Digital locker 120 is a remote online repository that is uniquely associated with the user's 105 account. As appreciated by those skilled in the art, the actual copies of the digital content 125 are not necessarily stored in the user's locker 120, but rather the locker 120 stores an indication of the rights of the user to the particular content 125 and a link or other reference to the actual digital content 125. Typically, the actual copy of the digital content 125 is stored in another mass storage (not shown). The digital lockers 120 of all of the users who have purchased a copy of a particular digital content 125 would point to this copy in mass storage. Of course, back up copies of all digital content 125 are maintained for disaster recovery purposes.

Although only one example of digital content 125 is illustrated in this Figure, it is appreciated that the lending server 150 can contain millions of files 125 containing digital content. It is also contemplated that the server 150 can actually be comprised of several servers with access to a plurality of storage devices containing digital content 125. As further appreciated by those skilled in the art, in conventional licensing programs, the user does not own the actual copy of the digital content, but has a license to use it. Hereinafter, if reference is made to “owning” the digital content, it is understood what is meant is the license or right to use the content.

The cloud 150 further has an Analytics section 160 that is used, as further described below, to derive information of users' behavior with respect to specific content. Although shown as only interacting with a single user's digital locker 120, those skilled in the art recognize that Analytics section 160 can receive data from the digital lockers 120 of every user of the system 100.

User 105 can access his or her digital locker 120 using a local device 130. Local device 130 is an electronic device such as a personal computer, a tablet, an e-book reader, a smart phone or other electronic device that the user 105 can use to access the server 150. In a preferred embodiment, the local device 130 has been previously associated, registered, with the user's account using user's account credentials. Local device 130 provides the capability for user 105 to download her copy of digital content 125 via her digital locker 120. After digital content 125 is downloaded to local device 130, user 105 can engage with the downloaded content locally, e.g., read the book, listen to the music or watch the video.

In a preferred embodiment, local device 130 includes a non-browser based device interface that allows user 105 to initiate the functionality of system 100 in a non-browser environment. Through the device interface, the user 105 is automatically connected to the server 150 in a non-browser based environment. This connection to the server 150 is a secure interface and can be through the telephone network 145, typically a cellular network for mobile devices. If user 105 is accessing his or her digital locker 120 using the Internet 140, local device 130 also includes a web account interface. Web account interface provides user 105 with browser-based access to his or her account and digital locker 120 over the Internet 140.

In its essential operation, the device 130 and the cloud infrastructure 150 work together using sourcing techniques and other algorithms (some deployed on the device 130 as described below) to interactions with digital publications such as books, magazines or other electronic content. As described above, the cloud infrastructure 150 has an Analytics 160 collection and reporting capability. In a preferred embodiment, there are about 300 such analytics collected today regarding a user's behavior on system 100. In a preferred embodiment, the analytic data collected from a user is stored in the user's digital locker 120. Analytic data in regard to a specific piece of content 125 can be stored separately, in parallel, in connection with the specific content 125.

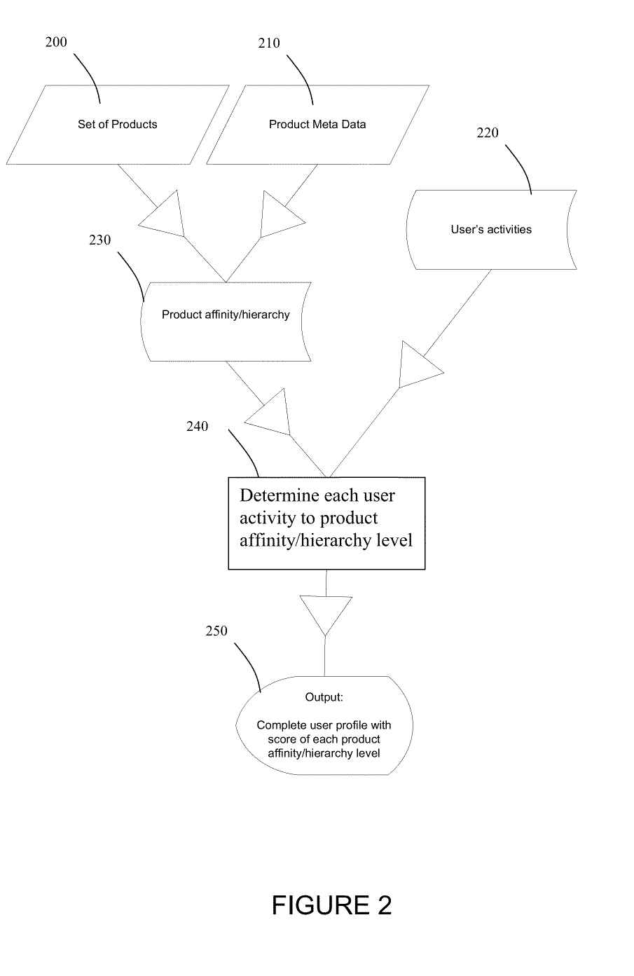

FIG. 2 illustrates a flow chart of a preferred method of the present invention. As seen in this Figure, the process uses databases containing the list of products 200, e.g., eBooks, and the metadata 210 associated with those products to generate a product affinity hierarchy 230. The product metadata 210 includes product attributes such as subject, author, readers category, price range, category and genre taxonomies.

For each product P defined with product attributes A={a1, a2, . . . , an}, the product affinity hierarchy 230 is determined for each attribute with respect to its sales volume S={S1, S2, . . . , Sn}, where Si is the total sales of products with attribute ai.

The system maintains a database 220 containing all of the user's activities within the system such as users' preferences, purchases, views and reads of content over a lengthy period of time. This data is preferable collected and maintained for each user in the system. For each user, this is maintained in database 220 as activity history H={(h₁, t₁), (h₂, t₂), . . . , (hₖ, tₖ)}, where hⱼ is activities such as product purchase, product view, like the product, recommend the product, rating or reviewing the product, etc., and tⱼ is a timestamp for when the activity took place.

In act 240, the system determines each user activity to product affinity/hierarchy level. In a preferred embodiment A fuction F(H, S, A) takes input parameters of product attribute A, attribute sales S and the user's history H, produces a result set R={(a₁, s₁), (a₂, s₂), . . . , (aₙ, sₙ)}, where sᵢ is the score of the user's affinity to attribute aᵢ. The results of this affinity determination is stored in act 250 in the respective user's profile in the system.

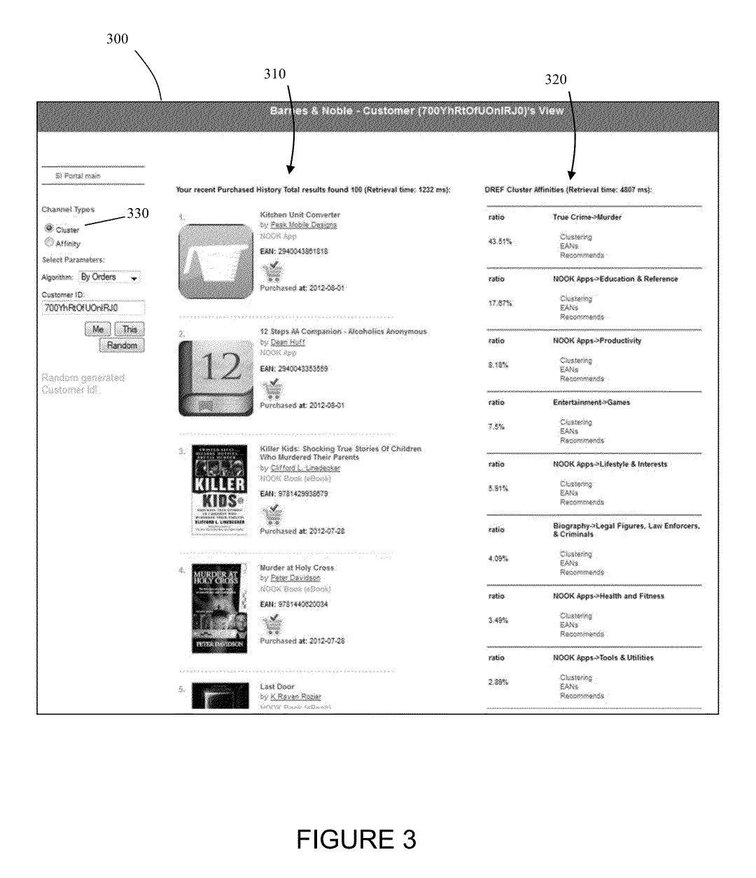

FIG. 3 depicts a user's most recent purchase history and the user's cluster affinities.

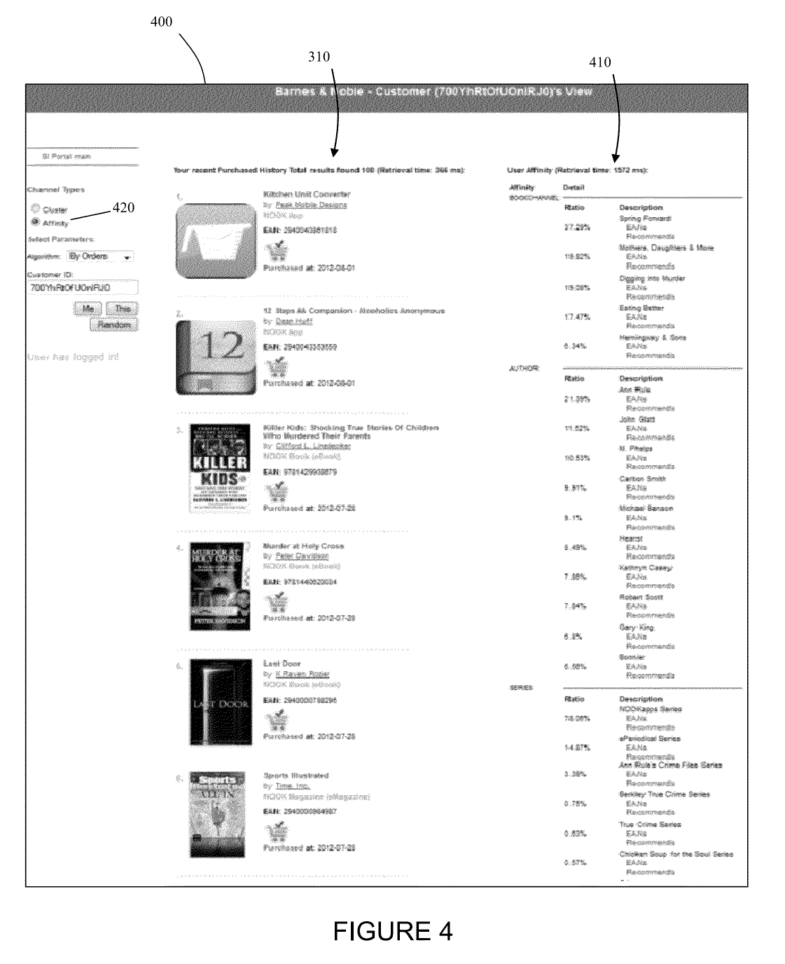

FIG. 4 depicts a user's affinities in regard to several categories.

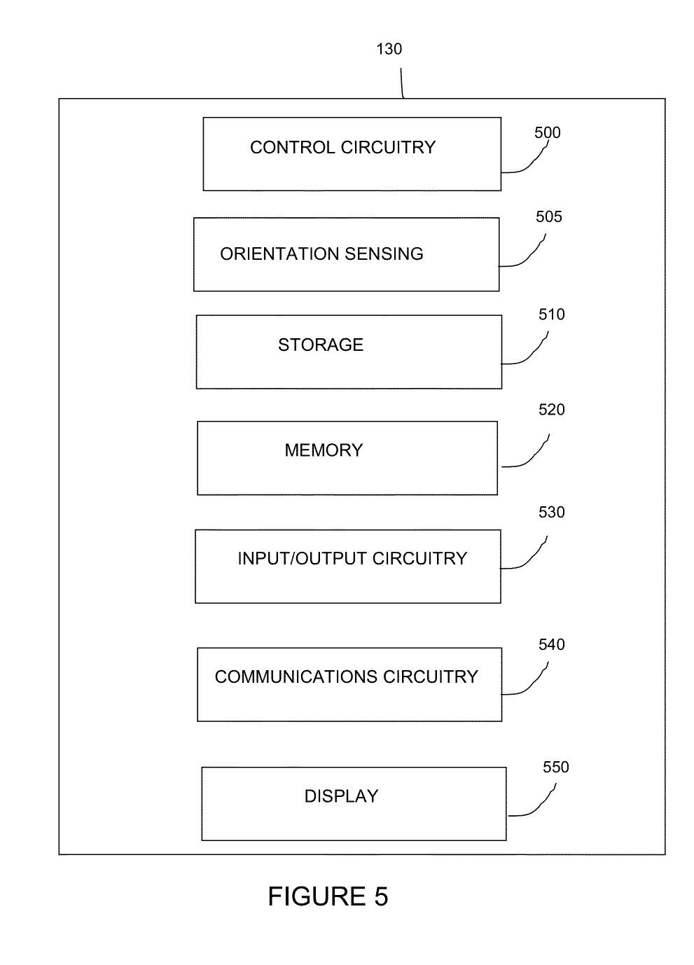

FIG. 5 illustrates an exemplary local device 130. As appreciated by those skilled the art, the local device 130 can take many forms capable of operating the present invention. As previously described, in a preferred embodiment the local device 130 is a mobile electronic device, and in an even more preferred embodiment device 130 is an electronic reader device. Electronic device 130 can include control circuitry 500, storage 510, memory 520, input/output (“I/O”) circuitry 530, communications circuitry 540, and display 550. In some embodiments, one or more of the components of electronic device 130 can be combined or omitted, e.g., storage 510 and memory 520 may be combined. As appreciated by those skilled in the art, electronic device 130 can include other components not combined or included in those shown in FIG. 4, e.g., a power supply such as a battery, an input mechanism, etc.

Electronic device 130 can include any suitable type of electronic device. For example, electronic device 130 can include a portable electronic device that the user may hold in his or her hand, such as a digital media player, a personal e-mail device, a personal data assistant (“PDA”), a cellular telephone, a handheld gaming device, a tablet device or an eBook reader. As another example, electronic device 130 can include a larger portable electronic device, such as a laptop computer. As yet another example, electronic device 130 can include a substantially fixed electronic device, such as a desktop computer.

Control circuitry 500 can include any processing circuitry or processor operative to control the operations and performance of electronic device 130. For example, control circuitry 500 can be used to run operating system applications, firmware applications, media playback applications, media editing applications, or any other application. Control circuitry 500 can drive the display 550 and process inputs received from a user interface, e.g., the display 550 if it is a touch screen.

Orientation sensing component 505 include orientation hardware such as, but not limited to, an accelerometer or a gyroscopic device and the software operable to communicate the sensed orientation to the control circuitry 500. The orientation sensing component 505 is coupled to control circuitry 500 that controls the various input and output to and from the other various components. The orientation sensing component 505 is configured to sense the current orientation of the portable mobile device 130 as a whole. The orientation data is then fed to the control circuitry 500 which control an orientation sensing application. The orientation sensing application controls the graphical user interface (GUI), which drives the display 550 to present the GUI for the desired mode.

Storage 510 can include, for example, one or more computer readable storage mediums including a hard-drive, solid state drive, flash memory, permanent memory such as ROM, magnetic, optical, semiconductor, paper, or any other suitable type of storage component, or any combination thereof. Storage 510 can store, for example, media content, e.g., eBooks, music and video files, application data, e.g., software for implementing functions on electronic device 130, firmware, user preference information data, e.g., content preferences, authentication information, e.g. libraries of data associated with authorized users, transaction information data, e.g., information such as credit card information, wireless connection information data, e.g., information that can enable electronic device 130 to establish a wireless connection), subscription information data, e.g., information that keeps track of podcasts or television shows or other media a user subscribes to, contact information data, e.g., telephone numbers and email addresses, calendar information data, and any other suitable data or any combination thereof. The instructions for implementing the functions of the present invention may, as non-limiting examples, comprise software and/or scripts stored in the computer-readable media 510.

Memory 520 can include cache memory, semi-permanent memory such as RAM, and/or one or more different types of memory used for temporarily storing data. In some embodiments, memory 520 can also be used for storing data used to operate electronic device applications, or any other type of data that can be stored in storage 510. In some embodiments, memory 520 and storage 510 can be combined as a single storage medium.

I/O circuitry 530 can be operative to convert, and encode/decode, if necessary analog signals and other signals into digital data. In some embodiments, I/O circuitry 530 can also convert digital data into any other type of signal, and vice-versa. For example, I/O circuitry 530 can receive and convert physical contact inputs, e.g., from a multi-touch screen, i.e., display 550, physical movements, e.g., from a mouse or sensor, analog audio signals, e.g., from a microphone, or any other input. The digital data can be provided to and received from control circuitry 500, storage 510, and memory 520, or any other component of electronic device 130. Although I/O circuitry 530 is illustrated in FIG. 3 as a single component of electronic device 130, several instances of I/O circuitry 530 can be included in electronic device 130.

Electronic device 130 can include any suitable interface or component for allowing a user to provide inputs to I/O circuitry 530. For example, electronic device 130 can include any suitable input mechanism, such as a button, keypad, dial, a click wheel, or a touch screen, e.g., display 550. In some embodiments, electronic device 130 can include a capacitive sensing mechanism, or a multi-touch capacitive sensing mechanism.

In some embodiments, electronic device 130 can include specialized output circuitry associated with output devices such as, for example, one or more audio outputs. The audio output can include one or more speakers, e.g., mono or stereo speakers, built into electronic device 130, or an audio component that is remotely coupled to electronic device 130, e.g., a headset, headphones or earbuds that can be coupled to device 130 with a wire or wirelessly.

Display 550 includes the display and display circuitry for providing a display visible to the user. For example, the display circuitry can include a screen, e.g., an LCD screen, that is incorporated in electronic device 130. In some embodiments, the display circuitry can include a coder/decoder (Codec) to convert digital media data into analog signals. For example, the display circuitry or other appropriate circuitry within electronic device 130 can include video Codecs, audio Codecs, or any other suitable type of Codec.

The display circuitry also can include display driver circuitry, circuitry for driving display drivers, or both. The display circuitry can be operative to display content, e.g., media playback information, application screens for applications implemented on the electronic device 130, information regarding ongoing communications operations, information regarding incoming communications requests, or device operation screens, under the direction of control circuitry 500. Alternatively, the display circuitry can be operative to provide instructions to a remote display.

Communications circuitry 540 can include any suitable communications circuitry operative to connect to a communications network and to transmit communications, e.g., data from electronic device 130 to other devices within the communications network. Communications circuitry 540 can be operative to interface with the communications network using any suitable communications protocol such as, for example, Wi-Fi, e.g., a 802.11 protocol, Bluetooth, radio frequency systems, e.g., 900 MHz, 1.4 GHz, and 5.6 GHz communication systems, infrared, GSM, GSM plus EDGE, CDMA, quadband, and other cellular protocols, VOIP, or any other suitable protocol.

Electronic device 130 can include one more instances of communications circuitry 540 for simultaneously performing several communications operations using different communications networks, although only one is shown in FIG. 4 to avoid overcomplicating the drawing. For example, electronic device 130 can include a first instance of communications circuitry 540 for communicating over a cellular network, and a second instance of communications circuitry 540 for communicating over Wi-Fi or using Bluetooth. In some embodiments, the same instance of communications circuitry 540 can be operative to provide for communications over several communications networks.

In some embodiments, electronic device 130 can be coupled to a host device such as digital content control server 150 for data transfers, synching the communications device, software or firmware updates, providing performance information to a remote source, e.g., providing riding characteristics to a remote server, or performing any other suitable operation that can require electronic device 130 to be coupled to a host device. Several electronic devices 130 can be coupled to a single host device using the host device as a server. Alternatively or additionally, electronic device 130 can be coupled to several host devices, e.g., for each of the plurality of the host devices to serve as a backup for data stored in electronic device 130.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

What is claimed is:

1. A method for recommending a product comprising:
generating a user profile based at least in part on an affinity of product attributes and a user's preference;
correlating the product attributes to each product affinity; and
generating the recommendation for a product based at least in part on the user profile and correlation of product attributes to each product affinity.

2. The method of claim 1 wherein the product is a book.

3. The method of claim 1 wherein the product attribute is a subject taxonomy.

4. The method of claim 1 wherein the product attribute is an author.

5. The method of claim 1 wherein the product attribute is a category.

6. The method of claim 1 wherein the product attribute is a genre taxonomy.

7. A method for recommending a product comprising:
generating a product affinity based at least in part on a set of products and associated meta data;
correlating user activity to product affinity;
generating a user profile with a score of each product affinity; and
recommending the product to a user based on the user profile.

8. The method of claim 7 wherein the product is a book.

9. The method of claim 7 wherein the product affinity is a subject taxonomy.

10. The method of claim 7 wherein the product affinity is an author.

11. The method of claim 7 wherein the product affinity is a category.

12. The method of claim 7 wherein the product affinity is a genre taxonomy.
